(19) United States
(12) Patent Application Publication
(10) Pub. No.: US 2021/0055844 A1
(43) Pub. Date: Feb. 25, 2021

(54) CONTENT MODIFICATIONS BASED ON TOUCH INPUTS

(71) Applicant: Hewlett-Packard Development Company, L.P., Spring, TX (US)

(72) Inventors: Thong Thai, Spring, TX (US); Monji G. Jabori, Spring, TX (US); Simon Wong, Spring, TX (US)

(73) Assignee: Hewlett-Packard Development Company, L.P., Spring, TX (US)

(21) Appl. No.: 16/977,845

(22) PCT Filed: Apr. 30, 2018
(86) PCT No.: PCT/US2018/030263

§ 371 Date: Sep. 3, 2020

(51) Int. Cl. G06F 3/0488; G06F 3/0482; G06F 3/14

(52) U.S. Cl. CPC G06F 3/0488; G06F 3/1454; G06F 3/0482

(57) ABSTRACT

An example electronic device includes a storage device to store second content associated with first content. The electronic device also includes a controller to: receive the first content and identification information of the first content from a host device; present the first content in a first virtual display; present the second content in a second virtual display based on the identification information; receive touch information of a touch input; determine a destination of the touch input; when the destination is the first virtual display, transmit converted touch information of the touch input to host device; and when the destination is the second virtual display, process the touch input to determine content operation information associated with the first content and transmit the content operation information to the host device.

### BACKGROUND

A computing device, such as a notebook computer, a tablet, may receive an input from a user of the computing device via different input devices. An example input device may be a keyboard. Another example input device may be a mouse.

### BRIEF DESCRIPTION OF THE DRAWINGS

Some examples of the present application are described with respect to the following figures:

FIG. 1 illustrates a functional block diagram of a system to perform an operation associated with content based on a touch input, according to an example;

FIG. 2 illustrates a functional block diagram of a system to perform an operation associated with content based on a touch input, according to another example;

FIG. 3A illustrates a first virtual display and a second virtual display where an operation associated with first content presented in the first virtual display may be performed via a touch input, according to an example;

FIG. 3B illustrates a performance of an operation associated with the first content based on a touch input detected in the first virtual display, according to an example;

FIG. 3C illustrates a performance of an operation associated with the first content based on a touch input detected in the second virtual display, according to an example;

FIG. 4 illustrate a method of operation to process a touch input at a controller of a display device, according to an example;

FIG. 5 illustrates a display device to process a touch input, according to an example; and

FIG. 6 illustrates a host device to perform an operation associated with content based on a touch input, according to an example.

### DETAILED DESCRIPTION

One approach to provide inputs to a computing device is via touch. For example, a user may use a finger or a stylus to directly interact with content displayed on a touch sensitive display device.

In some situations, a physical display device may display different content from a plurality of sources. The region on the display where content is presented or shown may be partitioned via processor executable instructions into a plurality of virtual displays. Each virtual display may be configured independently of the other virtual displays (e.g., different display resolutions, different sources, etc.). When a touch input is received to perform an operation associated with the content (e.g., to modify or update the content) in one of the virtual displays, there is a need to process the touch input so that the operation is performed with respect to the correct content.

Examples described herein provide an approach to perform an operation on content based on touch inputs. For example, an electronic device may include a storage device to store second content associated with first content. The electronic device also may include a controller to receive the first content and identification information of the first content from a host device; present the first content in a first virtual display; present the second content in a second virtual display based on the identification information; receive touch information of a touch input; and determine a destination of the touch input. When the destination is the first virtual display, the controller may transmit converted touch information of the touch input to host device. When the destination is the second virtual display, the controller may process the touch input to determine content operation information associated with the first content and transmit the content operation information to the host device.

In another example, an electronic device may include a storage device to store content. The electronic device may also include a controller to: transmit the content and identification information of the content to a display device; in response to receiving converted touch information associated with a touch input from the display device, perform a first operation associated with the content based on the converted touch information; and in response to receiving content operation information from the display device, perform a second operation associated with the content based on the content operation information. The content operation information may be determined based on the identification information and the touch input.

In another example, a non-transitory machine-readable storage medium comprising instructions that when executed cause a controller of an electronic device to: receive first content and identification information of the first content from a host device; present the first content in a first virtual display; determine second content associated with the first content based on the identification information; present the second content in a second virtual display; receive touch information of a touch input; transmit a set of coordinates associated with the touch input to the host device when the touch input is detected in the first virtual display; and transmit a command to the host device when the touch input is detected in the second virtual display. The first virtual display and the second virtual display may be non-overlapping. Examples described herein may enable an operation associated with content presented in a virtual display to be performed based on a touch input.

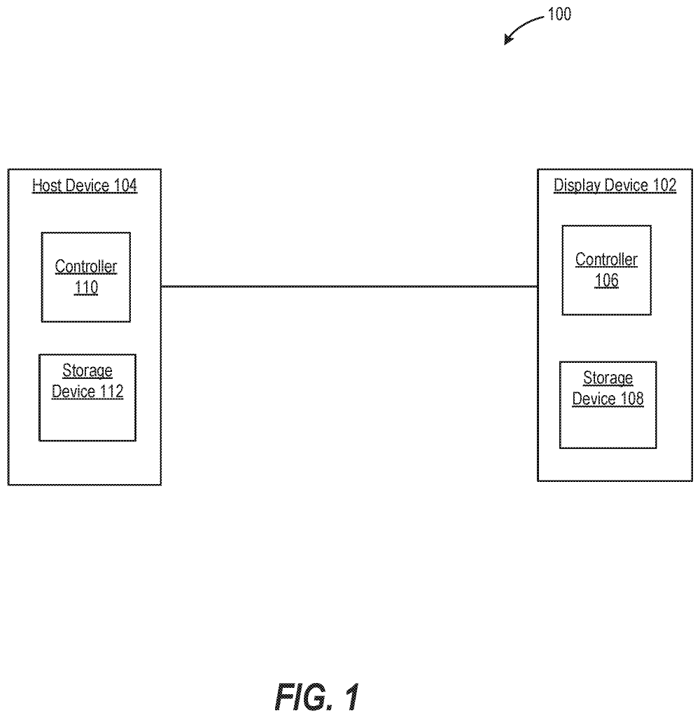

FIG. 1 illustrates a functional block diagram of a system 100 to modify content based on a touch input, according to an example. System 100 may include a display device 102 and a host device 104.

As used herein, display device 102 may be an electronic device that outputs information as images visible to humans, Display device 102 may be implemented using hardware components, processor executable instructions, or a combination thereof. Display device 102 may be a liquid crystal display (LCD), an organic light-emitting diode (OLED) display; a light-emitting diode (LED) display, etc.

As used herein, host device 104 may be an electronic device or component that generates content to be presented or shown on display device 102. Host device 104 may be implemented using hardware components, processor executable instructions, or a combination thereof. In some examples; host device 104 may be implemented as a standalone computing device, such as a desktop computer. In some examples, host device 104 and display device 102 may be integrated into a single device, such as a notebook computer, a tablet computer, an All-In-One (AiO) computer; a smart phone, etc. For example; host device 104 may be implemented as the computing portion (e.g., a central processor unit) of a notebook computer and display device 102 may be implemented as the display portion (e.g., an LCD).

Display device 102 may include a controller 106 and a storage device 108. Controller 106 may control operations of display device 102. Host device 104 may include a controller 110 and a storage device 112. Controller 110 may control operations of host device 104. Each of controllers 106 and 110 may be a central processing unit (CPU), a semiconductor-based microprocessor, and/or other hardware devices suitable for retrieval and execution of instructions stored in storage devices 108 and 112, respectively, Each of storage device 108 and 112 may be an electronic, magnetic, optical, or other physical storage device that contains or stores executable instructions, Storage device 108 and 112 may be, for example, Random Access Memory (RAM), an Electrically Erasable Programmable Read-Only Memory (EEPROM), a solid-state drive, an optical disc, etc.

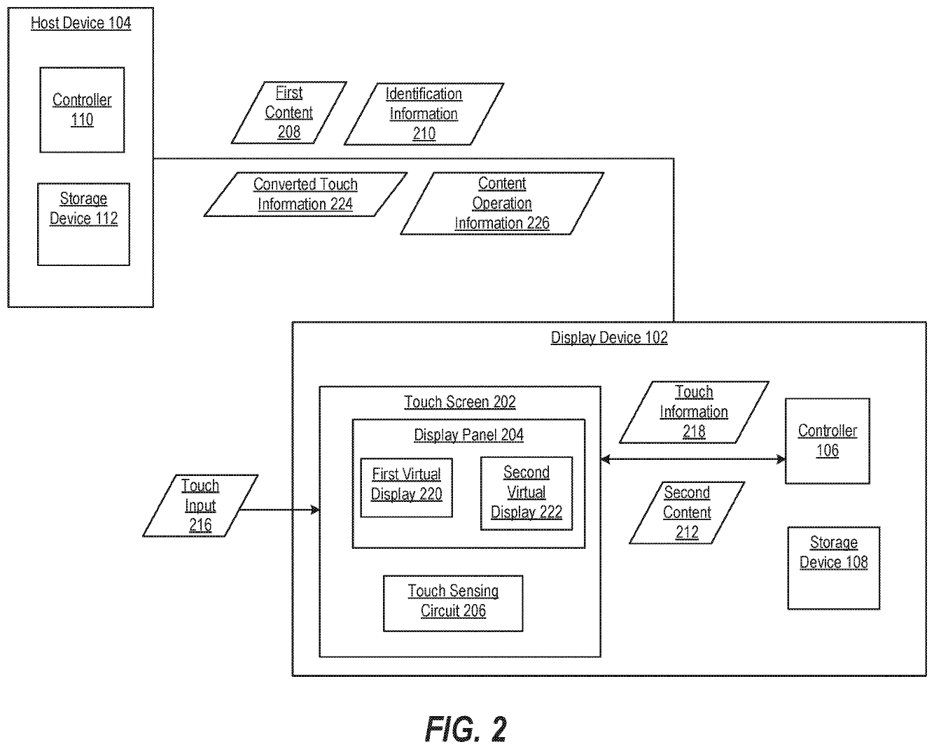

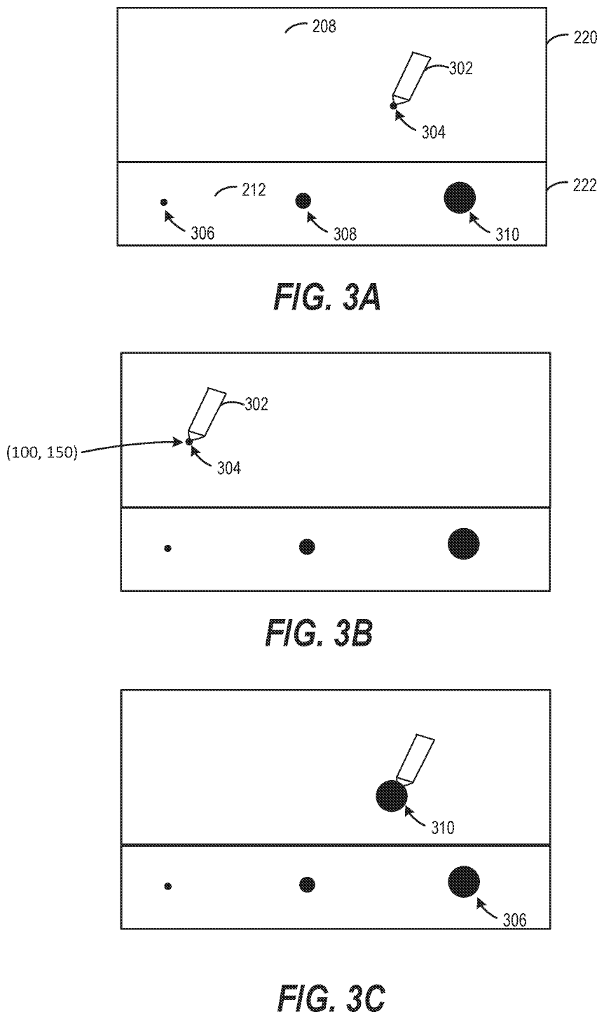

During operation, host device 104 may be connected to display device 102. In some examples, host device 104 may be connected to display device 102 via a physical cable. In some examples, host device 104 may be connected to display device 102 wirelessly, such as via Miracast or other wireless streaming protocols. Host device 104 may transmit content and identification information of the content to display device 102. Display device 102 may present the content and present second content based on the identification information. When display device 102 receives a touch input, display device 102 may transmit touch information associated with the touch input or content operation information based on a destination of the touch input. Host device 104 may perform an operation associated with the content based on the touch information or the content operation information. The operations of host device 104 and display device 102 are described in more detail in FIGS. 2 and 3A-3C.

Referring to FIG. 2, in some examples, display device 102 may also include a touch screen 202. As used herein, touch screen 202 may be an electronic device or component that presents electrical input signal as visual information and detects a physical touch with a surface of the electronic device or component. Touch screen 202 may include a display panel 204 to present electrical input signal as visual information. Display panel 204 may be implemented as a LCD panel, an OLED panel, a LED panel, etc. Touch screen 202 may also include a touch sensing circuit 206 to detect touch inputs. Touch sensing circuit 206 may be an electronic device or component that senses a physical contact (force or pressure) with a surface and outputs an electrical signal that indicates the contact. Touch sensing circuit 206 may sense the contact via a change in capacitance, resistance, magnetic field, etc. In some examples, touch sensing circuit 206 may include a touch sensor and a touch controller (not shown in the FIGs). In some examples, touch sensing circuit 206 may include a single touch sensor and the touch controller. In some examples, touch sensing circuit 206 may include a plurality of touch sensors and the touch controller.

During operation, host device 104 may generate first content 208 and identification information 210. As used herein, first content 208 may be data generated by instructions executable by controller 110. Identification information 210 may be data that describes what first content 208 is to another entity, such as display device 102. In some examples, first content 208 may correspond to data representing a graphical user interface (GUI) of an application executing at host device 104, Identification information 210 may correspond to a name of the application. In some examples, identification information 210 may correspond to a type of the application (e.g., a video game, a graphic design application, etc.).

Host device 104 may transmit first content 208 and identification information 210 to display device 102. In response to receiving first content 208 and identification information 210, display device 102 may, via controller 106, determine second content 212 based on identification information 210. As used herein, second content 212 may be data that is contextually related to first content 208. In an example described in more detail in FIGS. 3A-3C, first content 208 may be a GUI of a word processing application and second content 212 may be a menu of the application that provides options to change or modify an aspect of the GUI, such as opening a file, saving a file, etc.

Display device 102 may store a plurality of different content including second content 212 in storage device 108. Based on identification information 210, display device 102 may determine that second content 121 is associated with first content 208. For example, display device 102 may use a look-up table to identify what content is associated with first content 208 based on identification information 210.

Display device 102 may present first content 208 in a first virtual display 220 of display panel 204 and second content 212 in a second virtual display 222 of display panel 204. As used herein, a virtual display may be a region of display panel 204 where the boundaries or dimensions (e.g., length and width) are defined by machine-readable instructions (e.g., instructions executable by controller 106). First virtual display 220 may be occupy a first region of display panel 204 and second virtual display 222 may occupy a second region of display panel 204. In some examples, first virtual display 220 and second virtual display 222 may be non-overlapping. That is, the first region may not be able to extend into the second region or vice versa. First virtual display 220 may have a first display resolution and second virtual display 222 may have a second display resolution that is different from the first display resolution. Controller 106 may change a display resolution of first content 208 to match the display resolution of first virtual display 220, Controller 106 may change a display resolution of second content 212 to match the display resolution of second virtual display 222.

Touching sensing circuit 206 may detect a touch input 216 that corresponds to a physical contact on a sensing surface of touch sensing circuit 206. The physical contact may come from a finger or a stylus of a user. In response to detecting touch input 216, touch sensing circuit 206 may generate touch information 218. As used herein, touch information 218 may be data that describes a location on a sensing surface of touch sensing circuit 206 where touch input 216 is detected. In some examples, touch information 218 may include a particular set of coordinates relative to the sensing surface. The sensing surface may be aligned with display panel 204 so that the surface may cover display panel 204. The location on the sensing surface may be mapped to a corresponding location on display panel 204. Thus, the particular set of coordinates may be used to describe the corresponding location on display panel 204.

Touch sensing circuit 206 may transmit touch information 218 to controller 106. Controller 106 may determine a destination of touch input 216 based on touch information 218. The destination may be first virtual display 220 or second virtual display 222. Controller 106 may compare the particular set of coordinates in touch information 218 to a first set of coordinates (relative to the sensing surface) that are assigned to first virtual display 220 (i.e., coordinates of the first region where first virtual display 220 may occupy). Controller 106 may compare the set of coordinates in touch information 218 to a second set of coordinates (relative to the sensing surface) that are assigned to second virtual display 222 (i.e., coordinates of the second region where second virtual display 222 may occupy).

In response to determining that the particular set of coordinates in touch information 218 match a subset of the first set of coordinates, controller 106 may determine that the destination of touch input 216 to be first virtual display 220. In response to determining that the set of coordinates in touch information 218 match a subset of the second set of coordinates, controller 106 may determine that the destination of ouch input 216 to be second virtual display 222.

When the destination is first virtual display 220, controller 106 may generate converted touch information 224 by converting/mapping the particular set of coordinates in touch information 218 to a first set of internal coordinates relative to first virtual display 220. For example, the particular set of coordinates in touch information 218 may be (150, 300) and the first set of internal coordinates relative to first virtual display 220 may be (75, 150). Controller 106 may perform the conversion based on an aspect of first virtual display 220, such as a physical size, a display resolution, etc. Controller 106 may transmit converted touch information 224 to host device 104. Host device 104, via controller 110, may perform a first operation associated with first content 208 based on converted touch information 224.

Host device 104 may process converted touch information 224 as an input to control or interact with first content 208. Converted touch information 224 may indicate what portion or part of first content 208 is to be modified, Controller 110 may modify or update first content 208 based on converted touch information 224.

When the destination is second virtual display 222, instead of transmitting converted touch information 224, controller 106 may process touch input 216 to determine content operation information 226 that is associated with first content 208. For example, controller 106 may convert the particular set of coordinates in touch information 218 to a second set of internal coordinates relative to second virtual display 222, Controller 106 may determine what portion or part of second content 208 has been selected by touch input 216 based on the second set of internal coordinates. Controller 106 may generate content operation information 226 based on the second set of internal coordinates. Content operation information 226 may include a command to instruct host device 104 to perform an operation associated with first content 208. In some examples, the operation may be to modify or update first content 208, In some examples, the operation may be to perform a function associated with first content 208, such as saving first content 208 to a storage device, printing first content 208 via a printer, etc. Controller 106 may transmit content operation information 226 to host device 104. In response to receiving content operation information 226, host device 104, via controller 110, may perform a second operation associated with first content 208 based on content operation information 226.

Thus, based on where on touch screen 202 touch input 216 is received, display device 102 may either transmit a set of coordinates (e.g., converted touch information 224) or an instruction (e.g., content operation information 226) to host device 104. Host device 104 may process the set of coordinates to determine how first content 208 is to be modified. Host device 104 may then modify first content 208. Alternatively, host device 104 may perform an operation associated with first content 208 by following the instruction received from display device 102.

FIG. 3A illustrates first virtual display 220 and 222 second virtual display where an operation associated with first content 208 presented in first virtual display 220 may be performed via touch input 216, according to an example. FIGS. 3A-3C may be described with reference to FIG. 2A.

As illustrated in FIG. 3A, first content 208 may be data of a drawing application (implemented as processor executable instructions). For example, the data may represent a graphical user interface (GUI). As illustrated in FIG. 3A, the GUI may include a pen element 302 and a drawing dot 304. Pen element 302 may enable a user to draw in the GUI by moving pen element 302. Drawing dot 304 may indicate to the user the line weight of a line drawn by pen element 302. In second virtual display 222, second content 212 may be a menu associated with first content 208. For example, second content 212 may be a menu to select a line weight for the drawing application (i.e., first content 208). As illustrated in FIG. 3A, the menu may include a first line weight 306, a second line weight 308, and a third line weight 310. Line weights 306, 308, and 310 may be presented as drawing dots of different sizes. In FIG. 3A, drawing dot 304 may have first line weight 306. As illustrated in FIG. 3A, first virtual display 220 may be positioned above second virtual display 222. First virtual display 220 and second virtual display may be non-overlapping.

Referring to FIG. 3B, FIG. 3B illustrates a performance of an operation associated with first content 208 based on touch input 216 detected in first virtual display 220, according to an example. Touch input 216 may be detected at internal coordinates (100, 150) of first virtual display. Host device 104 may determine the corresponding internal coordinates (100, 150) based on converted touch information 224 received from display device 102. In response to touch input 216, host device 104 may perform an operation to modify pen element 302 and drawing dot 304. Host device 104 may modify/update the GUI so that drawing dot 304 may be moved to the internal coordinates (100, 150) and pen element 302 may be moved to a new location close to the internal coordinates.

Referring to FIG. 3C, FIG. 3C illustrates a performance of an operation associated with first content 208 based on touch input 216 detected in second virtual display 222, according to an example. Touch input 216 may be detected in second virtual display 222. The location of touch input 216 in second virtual display 222 may indicate that third line weight 306 has been selected. Thus, display device 102 may transmit content operation information 226 to host device 104. Content operation information 226 may instruct host device 104 to enlarge the visual representation of drawing dot 304 to match third line weight 310.

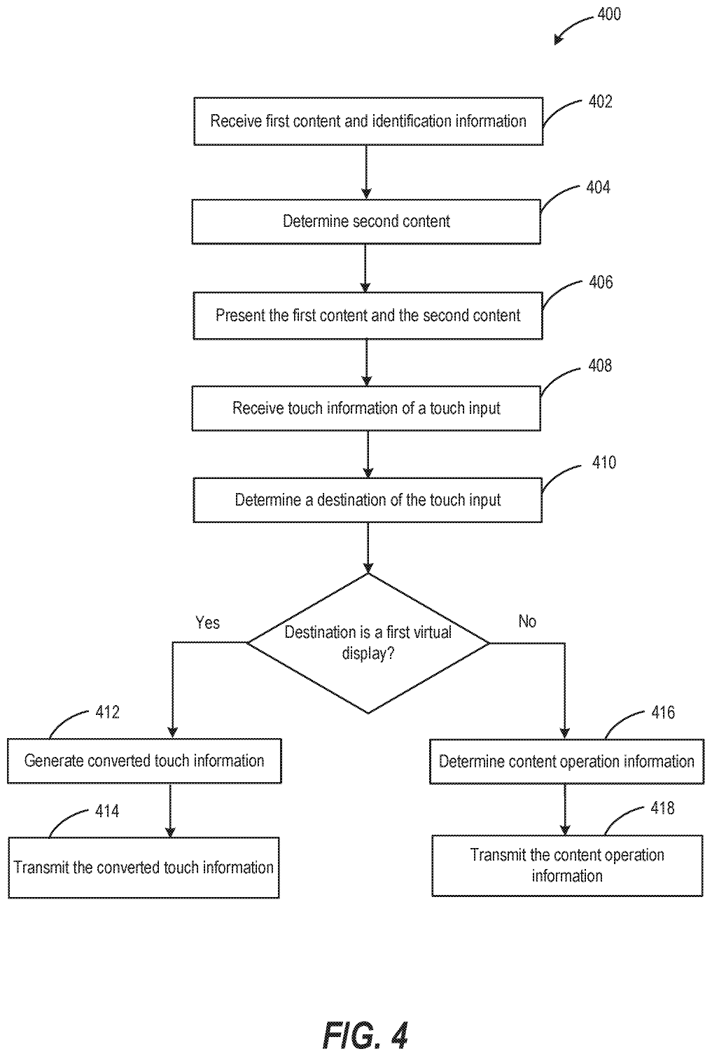

FIG. 4 illustrate a method 400 of operation to process a touch input at a controller of a display device, according to an example. Method 400 may be described with reference to FIG. 2. Method 400 may include receiving first content and identification information, at 402. Referring to FIG. 2, controller 106 may receive first content 208 and identification information 210 from host device 104. Method 400 may also include determining second content, at 404. Referring to FIG. 2, controller 106 may determine second content 212 based on identification information 210.

Method 400 may further include presenting the first content and the second content, at 406, Referring to FIG. 2, controller 106 may direct touch screen 202 to present first content 208 and second content 212. Method 400 may further include receiving touch information of a touch input, at 408. Referring to FIG. 2, controller 106 may receive touch information 218 from touch screen 202. Method 400 may further include determining a destination of the touch input, at 410. Referring to FIG. 2, controller 106 may determine a destination of touch input 216 based on touch information 218.

When the destination is first virtual display 220, method 400 may further include generate converted touch information, at 412. Referring to FIG. 2, controller 106 may generate converted touch information 224 by converting/mapping the particular set of coordinates in touch information 218 to a first set of internal coordinates relative to first virtual display 220. Method 400 may further include transmitting the converted touching information, at 414. Referring to FIG. 2, controller 106 may transmit converted touch information 224 to host device 104.

When the destination is second virtual display 222, method 400 may further include determining content operation information, at 416. Referring to FIG. 2, controller 106 may generate content operation information 226 based on the second set of internal coordinates. Method 400 may further include transmitting the content operation information, at 418. For example, controller 106 may transmit content operation information 226 to host device 104.

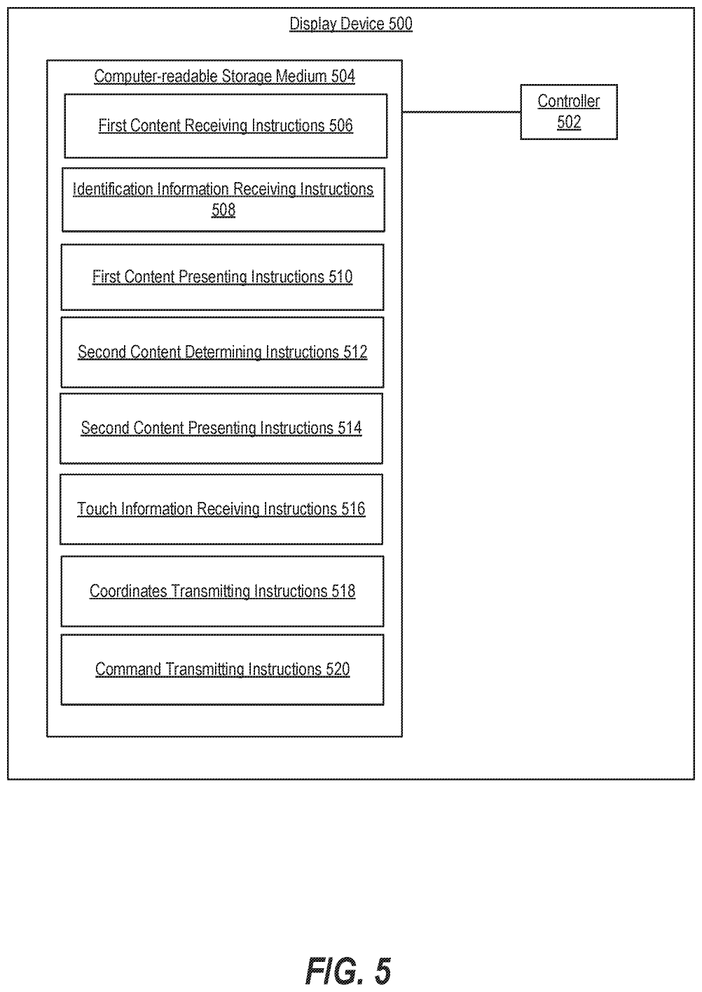

FIG. 5 illustrates a display device 500 to process a touch input, according to an example. Display device 500 may implement display device 102 of FIGS. 1-2. Display device 500 may include a controller 502 and a computer-readable storage medium 504.

Controller 502 may be a central processing unit (CPU), a semiconductor-based microprocessor, and/or other hardware devices suitable to control operations of display device 500. Computer-readable storage medium 504 may be any electronic, magnetic, optical, or other physical storage device that contains or stores executable instructions. Thus, computer-readable storage medium 504 may be, for example, Random Access Memory (RAM), an Electrically Erasable Programmable Read-Only Memory (EEPROM), a storage device, an optical disc, etc. In some examples, computer-readable storage medium 504 may be a non-transitory storage medium, where the term “non-transitory” does not encompass transitory propagating signals. Computer-readable storage medium 504 may be encoded with a series of executable instructions 506, 508, 510, 512, 514, 516, 518, and 520.

First content receiving instructions 506 may receive content from a host device, such as host device 104. For example, referring to FIG. 2, display device 102 may receive first content 208 from host device 104. Identification information receiving instructions 508 may receive identification information associated with the first content from the host device. For example, referring to FIG. 2, display device 102 may receive identification information 210 from host device 104. First content presenting instructions 510 may present the content on display device 500. For example, referring to FIG. 2, display device 102 may present first content 208 in first virtual display 220.

Second content determining instructions 512 may determine content based on the identification information. For example, referring to FIG. 2, display device 102 may determine second content 212 based on identification information 210. Second content presenting instructions 514 may content on display device 500. For example, referring to FIG. 2, display device 102 may present second content 212 in second virtual display 222 of display panel 204.

Touch information receiving instructions 516 may receive touch information of the touch input. For example, referring to FIG. 2, controller 106 may receive touch information 218 from touch sensing circuit 206. Coordinates transmitting instructions 518 may transmit a set of coordinates to the host device. For example, referring to FIG. 2, controller 106 may transmit converted touch information 224 to host device 104. Command transmitting instructions 520 may transmit a command to host device 104. For example, referring to FIG. 2, controller 106 may transmit content operation information 226 to host device 104.

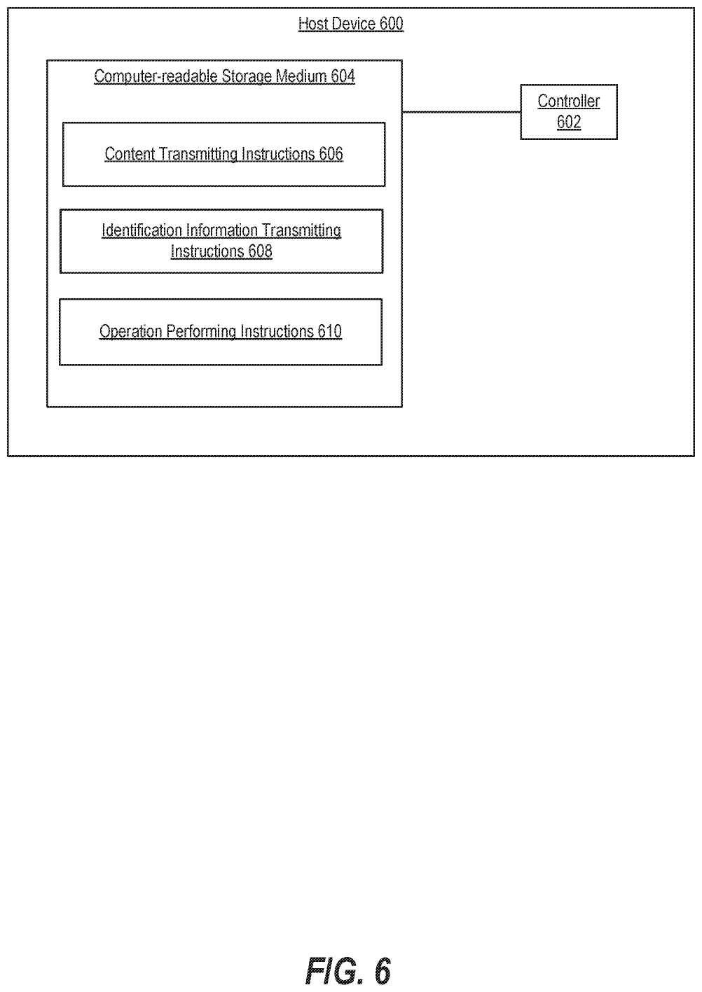

FIG. 6 illustrates a host device 600 to perform an operation associated with content based on a touch input, according to an example. Host device 600 may implement host device 104 of FIGS. 1-2. Host device 600 may include a controller 602 and a computer-readable storage medium 604. Controller 602 may be similar to controller 502 of FIG. 5. Computer-readable storage medium 604 may be similar to computer-readable storage medium 504. Computer-readable storage medium 604 may be encoded with instructions 606, 608, and 610.

Content transmitting instructions 606 may transmit content from host device 600 to a display device, such as display device 102. For example, referring to FIG. 2, host device 104 may transmit first content 208 to display device 102. Identification information transmitting instructions 608 may transmit identification information of the content to display device 102. For example, referring to FIG. 2, host device 104 may identification information 210 to display device 102. Operation performing instructions 610 may perform an operation on the content at host device 600. For example, referring to FIG. 2, in response to receiving content operation information 226, host device 104, via controller 110, may perform an operation associated with first content 208 based on content operation information 226.

The use of “comprising”, “including” or “having” are synonymous and variations thereof herein are meant to be inclusive or open-ended and do not exclude additional unrecited elements or method steps.

What is claimed is:

1. An electronic device comprising:
a storage device to store second content associated with first content; and
a controller to:
receive the first content and identification information of the first content from a host device;
present the first content in a first virtual display;
present the second content in a second virtual display based on the identification information;
receive touch information of a touch input;
determine a destination of the touch input;
when the destination is the first virtual display, transmit converted touch information of the touch input to host device; and
when the destination is the second virtual display:
process the touch input to determine content operation information associated with the first content; and
transmit the content operation information to the host device.

2. The electronic device of claim 1, further comprising:
a touch screen to:
present the first virtual display in a first region of the touch screen;
present the second virtual display in a second region of the touch screen; and
detect the touch input.

3. The electronic device of claim 2, wherein the touch information includes a particular set of coordinates relative to the touch screen, and wherein the controller is to determine the destination by comparing the particular set of coordinates to a first set of coordinates relative to the touch screen that are assigned to the first virtual display and to a second set of coordinates relative to the touch screen that are assigned to the second virtual display.

4. The electronic device of claim 3, wherein the converted touch information includes a set of coordinates relative to the first virtual display.

5. The electronic device of claim 2, wherein the touch screen includes a single touch sensor.

6. The electronic device of claim 1, wherein the controller is to change a display resolution of the first content to a display resolution of the first virtual display.

7. The electronic device of claim 1, wherein the first content corresponds to data of an application, and wherein the second content correspond to a menu of the application.

8. The electronic device of claim 1, wherein the first virtual display and the second virtual display are non-overlapping.

9. An electronic device comprising:
a storage device to store content; and
a controller to:
transmit the content and identification information of the content to a display device;
in response to receiving converted touch information associated with a touch input from the display device, perform a first operation associated with the content based on the converted touch information; and
in response to receiving content operation information from the display device, perform a second operation associated with the content based on the content operation information, wherein the content operation information is determined based on the identification information and the touch input.

10. The electronic device of claim 9, wherein the converted touch information includes a set of coordinates relative to a virtual display.

11. The electronic device of claim 9, wherein the content corresponds to a graphical user interface of an application.

12. The electronic device of claim 9, wherein the content operation information corresponds to a command to instruct the controller to perform the second operation.

13. A non-transitory machine-readable storage medium comprising instructions that when executed cause a controller of an electronic device to:
receive first content and identification information of the first content from a host device;
present the first content in a first virtual display;
determine second content associated with the first content based on the identification information;
present the second content in a second virtual display, wherein the first virtual display and the second virtual display are non-overlapping;
receive touch information of a touch input;
transmit a set of coordinates associated with the touch input to the host device when the touch input is detected in the first virtual display; and
transmit a command to the host device when the touch input is detected in the second virtual display.

14. The non-transitory machine-readable storage medium of claim 13, wherein the first content corresponds to a graphical user interface of an application, and wherein the second content corresponds to a menu of an application.

15. The non-transitory machine-readable storage medium of claim 14, wherein the command is to instruct the host device to perform an operation associated with the first content.
